(19) United States
(12) Patent Application Publication
(10) Pub. No.: US 2018/0196548 A1
(43) Pub. Date: Jul. 12, 2018

(54) TOUCH INPUT DEVICE FOR DETECTING TOUCH PRESSURE

(71) Applicant: HiDeep Inc., Gyeonggi-do (KR)

(72) Inventors: Se Yeob Kim, Gyeonggi-do (KR); Sang Sic Yoon, Gyeonggi-do (KR); Chi Woong Lee, Gyeonggi-do (KR); Bon Kee Kim, Gyeonggi-do (KR)

(21) Appl. No.: 15/741,698

(22) PCT Filed: Aug. 30, 2016
(86) PCT No.: PCT/KR2016/009615

§ 371 Date: Jan. 3, 2018

(30) Foreign Application Priority Data
Sep. 2, 2015 (KR) 10-2015-0124117

(51) Int. Cl. G06F 3/044

(52) U.S. Cl. CPC G06F 3/044; G06F 2203/04105

(57) ABSTRACT

According to one embodiment, a touch input device includes a pressure detection module for detecting the touch pressure, and a reference potential layer provided under the pressure detection module. The reference potential layer is composed of at least one of a battery having a conductive material and a can receiving other components. Through this, the touch input device is capable of the most efficient detection of the touch pressure when various components provided in the touch input device are used as the reference potential layer, or when there are a plurality of the reference potential layers. In particular, when the plurality of reference potential layers having various forms and shapes are provided, the most efficient reference potential layer can be selected.

### BACKGROUND

### Field

The present disclosure relates to a touch input device which detects a touch pressure.

### Description of the Related Art

Various kinds of input devices are being used to operate a computing system. For example, the input device includes a button, key, joystick and touch screen. Since the touch screen is easy and simple to operate, the touch screen is increasingly being used in operation of the computing system.

The touch screen may constitute a touch surface of a touch input device including a touch sensor panel which may be a transparent panel including a touch-sensitive surface. The touch sensor panel is attached to the front side of a display screen, and then the touch-sensitive surface may cover the visible side of the display screen. The touch screen allows a user to operate the computing system by simply touching the touch screen by a finger, etc. Generally, the computing system recognizes the touch and a position of the touch on the touch screen and analyzes the touch, and thus, performs the operations in accordance with the analysis.

Meanwhile, various types and shapes of display panels may be used in the touch screen. Therefore, the touch input device capable of efficiently detecting the touch position and touch pressure is increasingly required as the touch input device including the various types and shapes of display panels.

### SUMMARY

One embodiment is a touch input device which includes a display module and is capable of detecting a touch pressure, the touch input device including: a pressure detection module which is provided under the display module and includes a pressure electrode for detecting the touch pressure; and a reference potential layer which is provided under the pressure detection module. The pressure detection module detects the touch pressure on the basis of a capacitance change amount according to a distance change between the reference potential layer and the pressure electrode. The reference potential layer is composed of at least one of a battery having a conductive material and a can receiving other components.

The battery may be covered by the conductive material-made can connected to the ground (GND).

A conductive material-made tape layer or film layer connected to the ground (GND) may be formed on the battery.

At least one of a metal cover and an elastic material may be provided between the display module and the pressure detection module.

The display module may include an LCD panel and a backlight unit, and the pressure detection module may be provided under the backlight unit.

The display module may include an AM-OLED panel.

Another embodiment is a touch input device including: a display module in which a first reference potential layer is formed; a pressure detection module which is disposed under the display module and includes an insulation layer, a pressure electrode, and an elastic foam member; and a second reference potential layer and a third reference potential layer which are disposed under the pressure detection module. The pressure detection module detects a touch pressure on the basis of a capacitance change amount according to a distance change between the pressure electrode and one of the first to the third reference potential layers.

An air gap may be formed between the second reference potential layer and the third reference potential layer.

A spaced distance from the pressure electrode to the first to the third reference potential layers may be controlled by at least one of a thickness of the insulation layer, by a thickness of the elastic foam member, and a thickness of the air gap.

The capacitance change amount may be a self-capacitance change amount according to the distance change between the pressure electrode and one of the first to the third reference potential layers.

The pressure electrode may include a drive electrode and a receiving electrode, and the capacitance change amount may be a mutual capacitance change amount between the drive electrode and the receiving electrode, according to the distance change between the pressure electrode and one of the first to the third reference potential layers.

Further another embodiment is a touch input device including: a display module in which a first reference potential layer is formed; a pressure detection module which is disposed under the display module and detects a touch pressure; and a second reference potential layer and a third reference potential layer which are disposed under the pressure detection module. The pressure detection module includes an insulation layer in which a pressure electrode is formed; and an elastic foam member which is formed on and under the insulation layer. The pressure detection module detects a touch pressure on the basis of a capacitance change amount according to a distance change between the pressure electrode and one of the first to the third reference potential layers.

An air gap may be formed between the second reference potential layer and the third reference potential layer.

A spaced distance from the pressure electrode to the first to the third reference potential layers may be controlled by at least one of a thickness of the insulation layer, by a thickness of the elastic foam member, and a thickness of the air gap.

The capacitance change amount may be a self-capacitance change amount according to the distance change between the pressure electrode and one of the first to the third reference potential layers.

The pressure electrode may include a drive electrode and a receiving electrode, and the capacitance change amount may be a mutual capacitance change amount between the drive electrode and the receiving electrode, according to the distance change between the pressure electrode and one of the first to the third reference potential layers.

The capacitance change amount may be a self-capacitance change amount according to the distance change between the reference potential layer and the pressure electrode.

The pressure electrode may include a drive electrode and a receiving electrode, and the capacitance change amount may be a mutual capacitance change amount between the drive electrode and the receiving electrode, according to the distance change between the reference potential layer and the pressure electrode.

### BRIEF DESCRIPTION OF THE DRAWINGS

FIG. 1 is a view for describing a configuration and an operation of a touch sensor panel which is a component of a touch input device according to an embodiment of the present invention;

FIG. 2 shows a configuration of the touch input device according to the embodiment of the present invention;

FIGS. 3a to 3d are views for describing a touch pressure detection method and show a configuration of a pressure detection module according to the various embodiments of the present invention;

FIGS. 4a to 4f are cross sectional views of the pressure detection module which is one component of the touch input device according to various embodiment of the present invention;

FIGS. 5 to 10 are views showing various embodiments of a structural cross section of the touch input device according to the embodiment of the present invention;

FIGS. 11 and 12 are cross sectional views of the touch input device according to another embodiment of the present invention;

FIG. 13 is a cross sectional view of the touch input device according to further another embodiment of the present invention; and

FIG. 14 shows another embodiment of a battery shown in FIGS. 11 to 13.

### DETAILED DESCRIPTION

Specific embodiments of the present invention will be described in detail with reference to the accompanying drawings. The specific embodiments shown in the accompanying drawings will be described in enough detail that those skilled in the art are able to embody the present invention. Other embodiments other than the specific embodiments are mutually different, but do not have to be mutually exclusive. Additionally, it should be understood that the following detailed description is not intended to be limited.

The detailed descriptions of the specific embodiments shown in the accompanying drawings are intended to be read in connection with the accompanying drawings, which are to be considered part of the entire written description. Any reference to direction or orientation is merely intended for convenience of description and is not intended in any way to limit the scope of the present invention.

Specifically, relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation.

Terms such as “attached,” “affixed,” “connected,” “coupled,” “interconnected,” and similar refer to a relationship wherein structures are attached, connected or fixed to one another either directly or indirectly through intervening structures, as well as both movable or rigid attachments or relationships, unless expressly described otherwise.

Hereinafter, a touch input device according to an embodiment of the present invention will be described in detail with reference to the accompanying drawings.

The touch input device according to the embodiment of the present invention, which includes a display module and is capable of detecting a pressure, can be used not only in a portable electronic product such as a smartphone, smartwatch, tablet PC, laptop computer, personal digital assistant (PDA), MP3 player, camera, camcorder, electronic dictionary, etc., but also in an electric home appliance such as a home PC, TV, DVD, refrigerator, air conditioner, microwave, etc. Also, the touch pressure detectable touch input device including a display module in accordance with the embodiment of the present invention can be used without limitation in all of the products requiring a device for display and input such as an industrial control device, a medical device, etc.

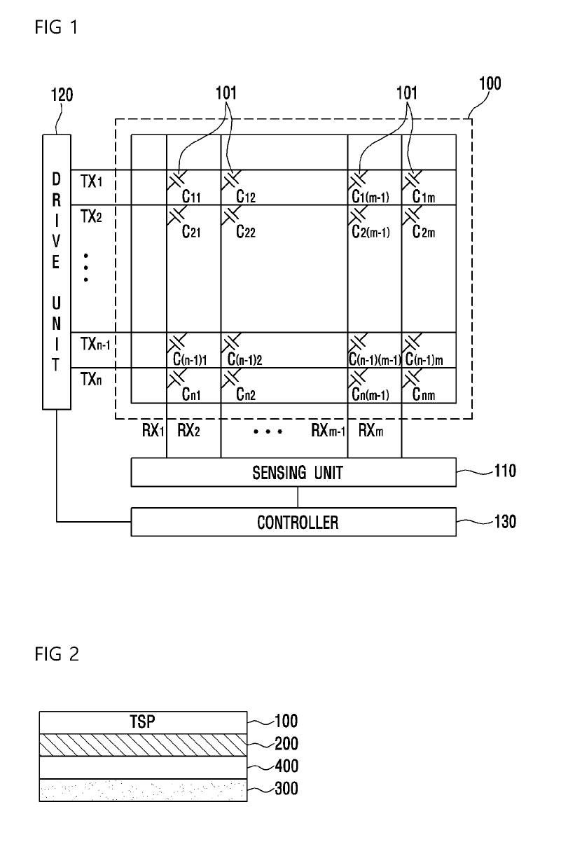

FIG. 1 is a view for describing a configuration and an operation of a capacitance type touch sensor panel 100 included in the touch input device according to the embodiment of the present. Referring to FIG. 1, the touch sensor panel 100 may include a plurality of drive electrodes TX1 to TXn and a plurality of receiving electrodes RX1 to RXm, and may include a drive unit 120 which applies a drive signal to the plurality of drive electrodes TX1 to TXn for the purpose of the operation of the touch sensor panel 100, and a sensing unit 110 which detects the touch and the touch position by receiving a sensing signal including information on a capacitance change amount changing according to the touch on the touch surface of the touch sensor panel 100.

As shown in FIG. 1, the touch sensor panel 100 may include the plurality of drive electrodes TX1 to TXn and the plurality of receiving electrodes RX1 to RXm. FIG. 1 shows that the plurality of drive electrodes TX1 to TXn and the plurality of receiving electrodes RX1 to RXm of the touch sensor panel 100 form an orthogonal array. However, the present invention is not limited to this. The plurality of drive electrodes TX1 to TXn and the plurality of receiving electrodes RX1 to RXm have an array of arbitrary dimension, for example, a diagonal array, a concentric array, a 3-dimensional random array, etc., and an array obtained by the application of them. Here, “n” and “m” are positive integers and may be the same as each other or may have different values. The magnitude of the value may be changed depending on the embodiment.

As shown in FIG. 1, the plurality of drive electrodes TX1 to TXn and the plurality of receiving electrodes RX1 to RXm may be arranged to cross each other. The drive electrode TX may include the plurality of drive electrodes TX1 to TXn extending in a first axial direction. The receiving electrode RX may include the plurality of receiving electrodes RX1 to RXm extending in a second axial direction crossing the first axial direction.

In the touch sensor panel 100 according to the embodiment of the present invention, the plurality of drive electrodes TX1 to TXn and the plurality of receiving electrodes RX1 to RXm may be formed in the same layer. For example, the plurality of drive electrodes TX1 to TXn and the plurality of receiving electrodes RX1 to RXm may be formed on the same side of an insulation layer (not shown). Also, the plurality of drive electrodes TX1 to TXn and the plurality of receiving electrodes RX1 to RXm may be formed in the different layers. For example, the plurality of drive electrodes TX1 to TXn and the plurality of receiving electrodes RX1 to RXm may be formed on both sides of one insulation layer (not shown) respectively, or the plurality of drive electrodes TX1 to TXn may be formed on a side of a first insulation layer (not shown) and the plurality of receiving electrodes RX1 to RXm may be formed on a side of a second insulation layer (not shown) different from the first insulation layer.

The plurality of drive electrodes TX1 to TXn and the plurality of receiving electrodes RX1 to RXm may be made of a transparent conductive material (for example, indium tin oxide (ITO) or antimony tin oxide (ATO) which is made of tin oxide (SnO₂), and indium oxide (In₂O₃), etc.), or the like. However, this is only an example. The drive electrode TX and the receiving electrode RX may be also made of another transparent conductive material or an opaque conductive material. For instance, the drive electrode TX and the receiving electrode RX may be formed to include at least any one of silver ink, copper, nano silver, or carbon nanotube (CNT). Also, the drive electrode TX and the receiving electrode RX may be made of metal mesh.

The drive unit 120 according to the embodiment may apply a drive signal to the drive electrodes TX1 to TXn. In the embodiment, one drive signal may be sequentially applied at a time to the first drive electrode TX1 to the n-th drive electrode TXn. The drive signal may be applied again repeatedly. This is only an example. The drive signal may be applied to the plurality of drive electrodes at the same time in accordance with the embodiment.

Through the receiving electrodes RX1 to RXm, the sensing unit 110 receives the sensing signal including information on a capacitance (Cm) 101 generated between the receiving electrodes RX1 to RXm and the drive electrodes TX1 to TXn to which the drive signal has been applied, thereby detecting whether or not the touch has occurred and where the touch has occurred. For example, the sensing signal may be a signal coupled by the capacitance (CM) 101 generated between the receiving electrode RX and the drive electrode TX to which the drive signal has been applied. As such, the process of sensing the drive signal applied from the first drive electrode TX1 to the n-th drive electrode TXn through the receiving electrodes RX1 to RXm can be referred to as a process of scanning the touch sensor panel 100.

For example, the sensing unit 110 may include a receiver (not shown) which is connected to each of the receiving electrodes RX1 to RXm through a switch. The switch becomes the on-state in a time interval during which the signal of the corresponding receiving electrode RX is detected, thereby allowing the receiver to detect the sensing signal from the receiving electrode RX. The receiver may include an amplifier (not shown) and a feedback capacitor coupled between the negative (−) input terminal of the amplifier and the output terminal of the amplifier, i.e., coupled to a feedback path. Here, the positive (+) input terminal of the amplifier may be connected to the ground. Also, the receiver may further include a reset switch which is connected in parallel with the feedback capacitor. The reset switch may reset the conversion from current to voltage that is performed by the receiver. The negative input terminal of the amplifier is connected to the corresponding receiving electrode RX and receives and integrates a current signal including information on the capacitance (CM) 101, and then converts the integrated current signal into voltage. The sensing unit 110 may further include an analog to digital converter (ADC) (not shown) which converts the integrated data by the receiver into digital data. Later, the digital data may be input to a processor (not shown) and processed to obtain information on the touch on the touch sensor panel 100. The sensing unit 110 may include the ADC and processor as well as the receiver.

A controller 130 may perform a function of controlling the operations of the drive unit 120 and the sensing unit 110. For example, the controller 130 generates and transmits a drive control signal to the drive unit 120, so that the drive signal can be applied to a predetermined drive electrode TX1 for a predetermined time period. Also, the controller 130 generates and transmits the drive control signal to the sensing unit 110, so that the sensing unit 110 may receive the sensing signal from the predetermined receiving electrode RX for a predetermined time period and perform a predetermined function.

In FIG. 1, the drive unit 120 and the sensing unit 110 may constitute a touch detection device (not shown) capable of detecting whether the touch has occurred on the touch sensor panel 100 or not and where the touch has occurred. The touch detection device may further include the controller 130. The touch detection device may be integrated and implemented on a touch sensing integrated circuit IC in a touch input device 1000 including the touch sensor panel 100. The drive electrode TX and the receiving electrode RX included in the touch sensor panel 100 may be connected to the drive unit 120 and the sensing unit 110 included in touch sensing IC 150 through, for example, a conductive trace and/or a conductive pattern printed on a circuit board, or the like. The touch sensing IC 150 may be placed on a circuit board on which the conductive pattern has been printed, for example, a first printed circuit board (hereafter, referred to as a first PCB). According to the embodiment, the touch sensing IC 150 may be mounted on a main board for operation of the touch input device 1000.

As described above, a capacitance (C) with a predetermined value is formed at each crossing of the drive electrode TX and the receiving electrode RX. When an object such as a finger approaches close to the touch sensor panel 100, the value of the capacitance may be changed. In FIG. 1, the capacitance may represent a mutual capacitance (Cm). The sensing unit 110 detects such electrical characteristics, thereby detecting whether the touch has occurred on the touch sensor panel 100 or not and where the touch has occurred. For example, the sensing unit 110 is able to detect whether the touch has occurred on the surface of the touch sensor panel 100 comprised of a two-dimensional plane consisting of a first axis and a second axis.

More specifically, when the touch occurs on the touch sensor panel 100, the drive electrode TX to which the drive signal has been applied is detected, so that the position of the second axial direction of the touch can be detected. Likewise, when the touch occurs on the touch sensor panel 100, the capacitance change is detected from the reception signal received through the receiving electrode RX, so that the position of the first axial direction of the touch can be detected.

The foregoing has described in detail the mutual capacitance type touch sensor panel as the touch sensor panel 100. However, in the touch input device 1000 according to the embodiment of the present invention, the touch sensor panel 100 for detecting whether or not the touch has occurred and the touch position may be implemented by using not only the above-described method but also any touch sensing method such as a self-capacitance type method, a surface capacitance type method, a projected capacitance type method, a resistance film method, a surface acoustic wave (SAW) method, an infrared method, an optical imaging method, a dispersive signal technology, and an acoustic pulse recognition method, etc.

In the touch input device 1000 to which a pressure detection module according to the embodiment can be applied, the touch sensor panel 100 for detecting the touch position may be positioned outside or inside the display module 200.

The display panel included in the display module 200 of the touch input device 1000 to which the pressure detection module according to the embodiment can be applied may be an organic light emitting diode (OLED). The OLED may be an AM-OLED or PM-OLED.

However, the display module 200 of the touch input device 1000 according to the embodiment is not limited to this. The display module 200 may be another type of module capable of displaying such as liquid crystal display (LCD), a plasma display panel (PDP), etc.

Accordingly, a user may perform the input operation by touching the touch surface while visually identifying an image displayed on the display panel. Here, the display module 200 may include a control circuit which receives an input from an application processor (AP) or a central processing unit (CPU) on a main board for the operation of the touch input device 1000 and displays the contents that the user wants on the display panel. This control circuit may be mounted on a second printed circuit board (not shown). Here, the control circuit for the operation of the display panel may include a display panel control IC, a graphic controller IC, and other circuits required to operate the display panel.

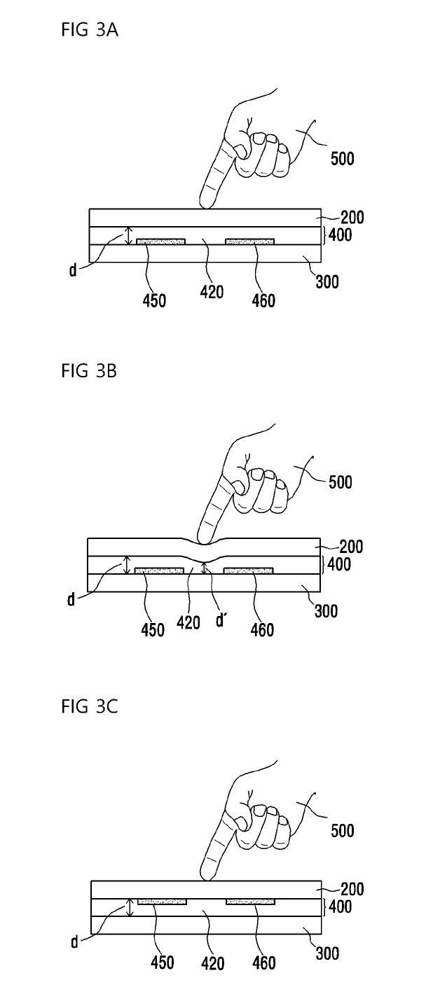

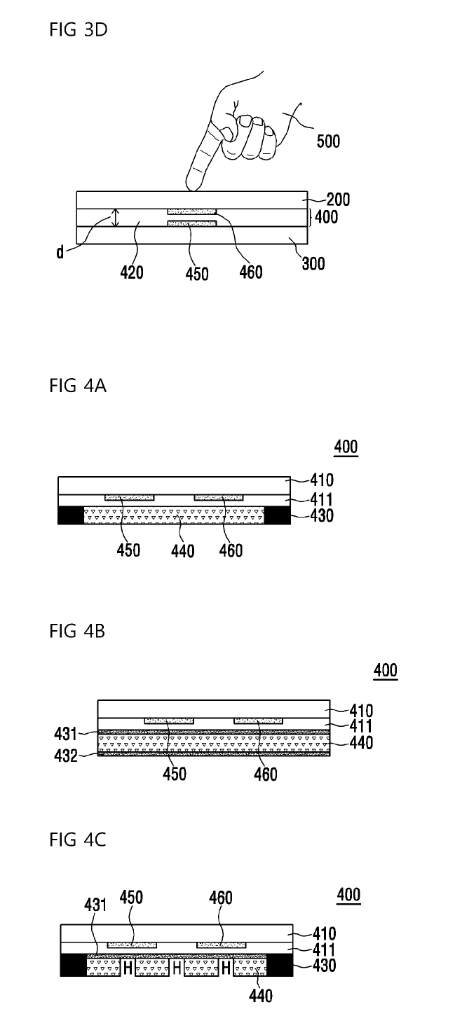

Following the above description of the operation of the touch sensor panel 100 which detects the touch position, a method and principle of detecting the touch pressure will be described with reference to FIGS. 2 and 3a to 3d.

FIG. 2 shows a configuration of the touch input device 1000 according to the embodiment of the present invention. FIGS. 3a to 3d are views showing a method of detecting the touch pressure and various embodiments of a pressure detection module 400 for the same.

As shown in FIG. 2, the touch input device 1000 according to the embodiment of the present invention includes the touch sensor panel 100, the display module 200, the pressure detection module 400, and a substrate 300. Here, the substrate 300 may be a reference potential layer. The reference potential layer of the touch input device 1000 according to another embodiment of the present invention may be arranged differently from the arrangement of FIG. 2. That is, the reference potential layer may be located on the pressure detection module 400 or may be located within the display module 200. Also, one or more reference potential layers may be provided. Here, the pressure detection module 400 may be disposed differently in response to the stack structure of the touch input device 1000. This will be described in detail in the description of the embodiment of FIGS. 3a to 3d.

As shown in FIG. 3a, a spacer layer 420 may be disposed between the display module 200 and the substrate 300. Pressure electrodes 450 and 460 disposed according to the embodiment shown in FIG. 3a may be placed between the display module 200 and the substrate 300 and may be disposed on the substrate 300 side.

The pressure electrode for detecting the pressure may include a first electrode 450 and a second electrode 460. Here, one of the first electrode 450 and the second electrode 460 may be a drive electrode and the other may be a receiving electrode. The drive signal is applied to the drive electrode, and the sensing signal may be obtained through the receiving electrode. When voltage is applied, the mutual capacitance may be generated between the first electrode 450 and the second electrode 460.

FIG. 3b is a cross sectional view when the pressure is applied to the touch input device 1000 shown in FIG. 3a. The bottom surface of the display module 200 may have a ground potential in order to block the noise. When the pressure is applied to the surface of the touch sensor panel 100 by an object 500, the touch sensor panel 100 and the display module 200 may be bent. As a result, a distance “d” between the pressure electrode pattern 450 and 460 and a ground potential surface, i.e., the reference potential layer may be reduced to “d′”. In this case, due to the reduction of the distance “d”, fringing capacitance is absorbed in the bottom surface of the display module 200, so that the mutual capacitance between the first electrode 450 and the second electrode 460 may be reduced. Therefore, the magnitude of the touch pressure can be calculated by obtaining the reduction amount of the mutual capacitance from the sensing signal obtained through the receiving electrode.

In the touch input device 1000 according to the embodiment of the present invention, when the touch pressure is applied to the display module 200, the display module 200 may be bent in such a manner as to show the biggest transformation at the touch position. When the display module 200 is bent according to the embodiment, a position showing the biggest transformation may not match the position where the touch has occurred. However, the display module 200 may be shown to be bent at least at the corresponding touch position. For example, when the touch position approaches close to the border, edge, etc., of the display module 200, the most bent position of the display module 200 may not match the touch position. However, the display module 200 may be shown to be bent at least at the touch position.

FIG. 3c shows a pressure electrode arrangement of the touch input device 1000 according to further another embodiment of the present invention. In the electrode arrangement shown in FIG. 3c, the pressure electrodes 450 and 460 may be located between the display module 200 and the substrate 300 and may be disposed the display module 200 side.

While it is shown in the embodiments of FIGS. 3a and 3b that the pressure electrodes 450 and 460 are formed on the substrate 300, it can be also considered that the pressure electrodes 450 and 460 are formed on the bottom surface of the display module 200. Here, the substrate 300 as the reference potential layer may have a ground potential. Therefore, the distance “d” between the substrate 300 and the pressure electrodes 450 and 460 is reduced by the touch on the touch surface of the touch sensor panel 100. This causes the change of the mutual capacitance between the first electrode 450 and the second electrode 460.

FIG. 3d shows a pressure electrode arrangement of the touch input device 1000 according to yet another embodiment of the present invention. In the embodiment of FIG. 3d, one of the first electrode 450 and the second electrode 460, which are the pressure electrodes, may be formed on the substrate 300 side and the other may be formed on the bottom surface side of the display module 200. FIG. 3d shows that the first electrode 450 is formed on the substrate 300 side and the second electrode 460 is formed on the bottom surface side of the display module 200. Needless to say, this can be implemented in a manner to replace the positions of the first and second electrodes 450 and 460 with each other.

When the object 500 applies a pressure to the surface of the touch sensor panel 100, the touch sensor panel 100 and the display module 200 shown in FIG. 2 may be bent. Accordingly, the distance “d” between the first electrode 450 and the second electrode 460 may decrease. In this case, due to the decrease of the distance “d”, the mutual capacitance between the first electrode 450 and the second electrode 460 may be reduced. Thus, the reduced amount of the mutual capacitance is obtained from the sensing signal obtained through the receiving electrode, so that the magnitude of the touch pressure can be calculated.

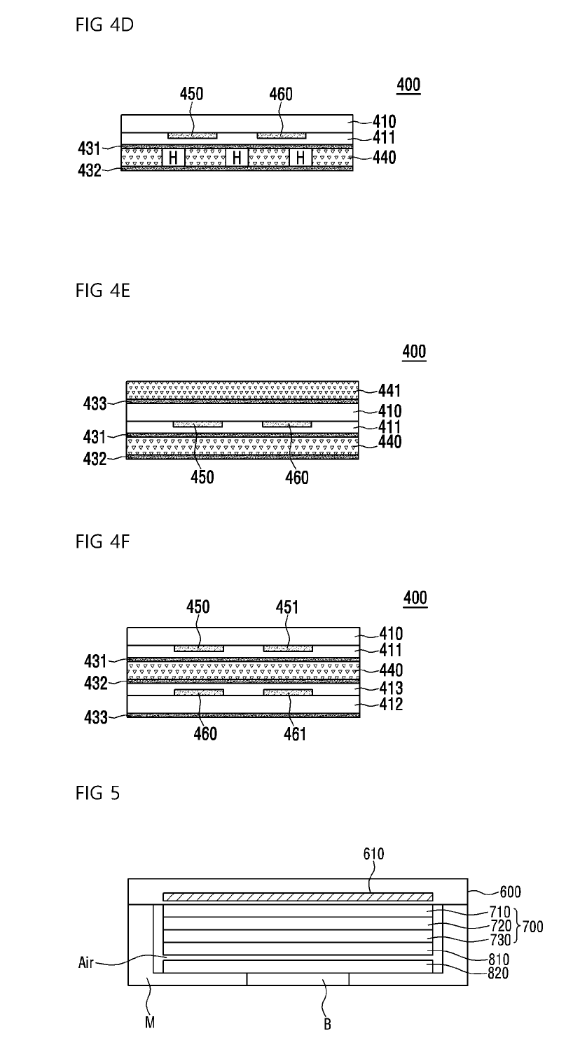

FIGS. 4a to 4f show structural cross sections of the pressure detection module 400 which is one component of the touch input device 1000 according to various embodiment of the present invention.

As shown in FIG. 4a, in the pressure electrode module 400, the pressure electrodes 450 and 460 are located between a first insulation layer 410 and a second insulation layer 411. For example, the pressure electrodes 450 and 460 may be formed on the first insulation layer 410, and then may be covered with the second insulation layer 411. Here, the first insulation layer 410 and the second insulation layer 411 may be made of an insulating material such as a polyimide. The first insulation layer 410 may be polyethylene terephthalate (PET) and the second insulation layer 411 may be a cover layer made of ink. The pressure electrodes 450 and 460 may include a material such as copper or aluminum. According to the embodiment, by an adhesive (not shown) such as a liquid adhesive, the first insulation layer 410 and the second insulation layer 411 may be adhered to each other, and the first insulation layer 410 and the pressure electrodes 450 and 460 may be adhered to each other. Also, according to the embodiment, the pressure electrodes 450 and 460 may be formed by positioning a mask, which has a through-hole corresponding to a pressure electrode pattern, on the first insulation layer 410, and then by spraying a conductive material.

In FIG. 4a, the pressure detection module 400 may further include an elastic foam member 440. The elastic foam member 440 may be formed on a side of the second insulation layer 411 in such a manner as to be opposite to the first insulation layer 410. Later, when the pressure detection module 400 is attached to the substrate 300, the elastic foam member 440 may be disposed on the substrate 300 side with respect to the second insulation layer 411.

Here, in order to attach the pressure detection module 400 to the substrate 300, an adhesive tape 430 having a predetermined thickness may be formed on the outskirt of the elastic foam member 430. According to the embodiment, the adhesive tape 430 may be a double adhesive tape. Here, the adhesive tape 430 may also function to adhere the elastic foam member 430 to the second insulation layer 411. Here, the adhesive tape 430 is disposed on the outskirt of the elastic foam member 430, so that the thickness of the pressure detection module 400 can be effectively reduced.

When the pressure detection module 400 shown in FIG. 4a is attached to the substrate 300 disposed thereunder, the pressure electrodes 450 and 460 may operate to detect the pressure. For instance, the pressure electrodes 450 and 460 are disposed on the display module 200 side. The reference potential layer may correspond to the substrate 300, and the elastic foam member 440 may perform operations corresponding to the spacer layer 420. For example, when the top of the touch input device 1000 is touched, the elastic foam member 440 is pressed and the distance between the pressure electrodes 450 and 460 and the substrate 300, i.e., the reference potential layer is reduced. As a result, the mutual capacitance between the first electrode 405 and the second electrode 460 may be reduced. Through such a change of the capacitance, the magnitude of the touch pressure can be detected.

In FIG. 4b, unlike FIG. 4a, the pressure detection module 400 is not attached to the substrate 300 through the adhesive tape 430 disposed on the outskirt of the elastic foam member 440. In FIG. 4b, a first adhesive tape 431 for adhering the elastic foam member 440 to the second insulation layer 411 and a second adhesive tape 432 for adhering the pressure detection module 400 to the substrate 300 are included on the elastic foam member 440. As such, the first adhesive tape 431 and the second adhesive tape 432 are disposed, so that the elastic foam member 440 can be securely attached to the second insulation layer 411 and the pressure detection module 400 can be securely attached to the substrate 300. According to the embodiment, the pressure detection module 400 shown in FIG. 4b may not include the second insulation layer 411. For example, the first adhesive tape 431 may not only function as a cover layer covering directly the pressure electrodes 450 and 460 but also function to attach the elastic foam member 440 to the first insulation layer 410 and the pressure electrodes 450 and 460. This can be applied to the following FIGS. 4c to 4f.

FIG. 4c shows a modified example of the structure shown in FIG. 4a. In FIG. 4c, a hole “H” extending through the height of the elastic foam member 440 is formed in the elastic foam member 440, thereby causing the elastic foam member 440 to be well pressed by the touch on the touch input device 1000. The hole “H” may be filled with air. When the elastic foam member 440 is well pressed, the sensitivity for the pressure detection can be improved. Also, the hole “H” formed in the elastic foam member 400 makes it possible to prevent the surface of the elastic foam member 400 from protruding due to the air at the time of attaching the pressure detection module 400 to the substrate 300, etc. In FIG. 4c, for the purpose of securely attaching the elastic foam member 400 to the second insulation layer 411, the first adhesive tape 431 as well as the adhesive tape 430 may be further included.

FIG. 4d shows a modified example of the structure shown in FIG. 4b. As with FIG. 4c, the hole “H” extending through the height of the elastic foam member 440 is formed in the elastic foam member 440.

FIG. 4e shows a modified example of the structure shown in FIG. 4b. A second elastic foam member 441 may be further included on one side of the first insulation layer 410, that is, the opposite side to the elastic foam member 440. The second elastic foam member 441 may be further formed in order to minimize the impact transmitted to the display module 200 when the pressure detection module 400 is later attached to the touch input device 1000. Here, a third adhesive layer 433 for adhering the second elastic foam member 441 to the first insulation layer 410 may be further included.

FIG. 4f shows a structure of the pressure detection module 400 capable of operating to detect the pressure. FIG. 4f shows the structure of the pressure detection module 400, in which the first electrodes 450 and 451 and the second electrodes 460 and 461 are disposed with the elastic foam member 440 placed therebetween. Similarly to the structure described with reference to FIG. 4b, the first electrodes 450 and 451 may be formed between the first insulation layer 410 and the second insulation layer 411, and the first adhesive tape 431, the elastic foam member 440, and the second adhesive tape 432 may be formed. The second electrodes 460 and 461 may be formed between a third insulation layer 412 and a fourth insulation layer 413, and the fourth insulation layer 413 may be attached to one side of the elastic foam member 440 by means of the second adhesive tape 432. Here, the third adhesive tape 433 may be formed on the substrate-side surface of the third insulation layer 412. The pressure detection module 400 may be attached to the substrate 300 by means of the third adhesive tape 433. As described with reference to FIG. 4b, according to the embodiment, the pressure detection module 400 shown in FIG. 4f may not include the second insulation layer 411 and/or the fourth insulation layer 413. For example, the first adhesive tape 431 may not only function as a cover layer covering directly the first electrodes 450 and 451 but also function to attach the elastic foam member 440 to the first insulation layer 410 and the first electrodes 450 and 451. Also, the second adhesive tape 432 may not only function as a cover layer covering directly the second electrodes 460 and 461 but also function to attach the elastic foam member 440 to the third insulation layer 412 and the second electrodes 460 and 461.

Here, the elastic foam member 440 is pressed by the touch on the touch input device 1000, and thus, the mutual capacitance between the first electrodes 450 and 451 and the second electrodes 460 and 461. Through such a change of the capacitance, the touch pressure can be detected. Also, according to the embodiment, any one of the first electrodes 450 and 451 and the second electrodes 460 and 461 is maintained at the ground potential, and then the self-capacitance can be detected by the other electrode.

In FIG. 4f, although the thickness and manufacturing cost of the pressure detection module 400 are higher than those of a case where the electrode is formed as a single layer, it is ensured that a pressure detection performance is not changed according to the characteristics of the reference potential layer located outside the pressure detection module 400. That is, the pressure detection module 400 is formed as shown in FIG. 4f, so that an effect caused by an external potential (ground) environment can be minimized in the pressure detection. Therefore, regardless of the type of the touch input device 1000 to which the pressure detection module 400 is applied, the same pressure detection module 400 can be used.

In the foregoing, the pressure detection based on the mutual capacitance change amount which changes as the drive electrode and the receiving electrode become close to the reference potential layer has been described by using the pressure electrode including the drive electrode and the receiving electrode. However, the pressure detection module 400 according to the embodiment of the present invention is able to detect the touch pressure on the basis of the self-capacitance change amount.

Briefly describing, the touch pressure can be detected by using self-capacitance formed between the pressure electrode (the drive electrode or the receiving electrode may be used as the pressure electrode) and the reference potential layer. In other words, the touch pressure can be detected by using self-capacitance which is formed between the drive electrode and the reference potential layer and/or between the receiving electrode and the reference potential layer. When the touch pressure is not applied even by user's touch, the distance between the pressure electrode and the reference potential layer is not changed, so that the value of the self-capacitance is not changed. In this case, only the touch position by the touch sensor panel 100 would be detected. However, when even the touch pressure is applied, the value of the self-capacitance is changed in the above manner, and the pressure detection module 400 detects the touch pressure on the basis of the change amount of the self-capacitance.

Specifically, when the pressure is applied by the touch, the reference potential layer or the pressure electrode (the drive electrode or the receiving electrode may be used as the pressure electrode) moves, so that the distance between the reference potential layer and the pressure electrode is reduced and the value of the self-capacitance is increased. On the basis of the increased value of the self-capacitance, the touch pressure is detected by determining the magnitude of the touch pressure.

FIGS. 5 to 10 show structural cross section of the touch input device according to various embodiments of the present invention.

The touch input device shown in FIG. 5 includes a plurality of reference potential layers 610, 810, and 820. Specifically, the first reference potential layer 610 is included within a display module 600 or on the bottom surface of the display module 600. Also, a pressure detection module 700 includes an insulation layer 710, a pressure electrode 720, and an elastic foam member 730. The second reference potential layer 810 and the third reference potential layer 820 are disposed under the pressure detection module 700.

The insulation layer 710 constituting the pressure detection module 700 may be made of polyethylene terephthalate (PET). The pressure electrode 720 may include a material such as copper or aluminum. Also, the elastic foam member 730 may be formed in the manner shown in FIGS. 4a to 4f. However, as described above, the elastic foam member 730 is not limited to this.

Further, respective components of the pressure detection module 700 may be adhered by an adhesive (not shown) such as a liquid adhesive. Also, according to the embodiment, the pressure electrode 720 may be formed by positioning a mask, which has a through-hole corresponding to a pressure electrode pattern, on or under the insulation layer 710, and then by spraying a conductive material.

Meanwhile, the first reference potential layer 610 included in the display module 600 (formed within the display module 600 or on the bottom surface of the display module 600) may be used to drive the display module 600 or to detect the pressure.

A predetermined air gap may be, as shown in FIG. 5, formed between the second reference potential layer 810 and the third reference potential layer 820 which are provided under the pressure detection module 700. The predetermined air gap may be several tens of micrometers. The present invention is not limited to the above air gap.

Meanwhile, by appropriately adjusting the air gap between the second reference potential layer 810 and the third reference potential layer 820, a spaced distance from the pressure electrode 720 can be controlled.

For example, in order to make a relative distance from the second reference potential layer 810 to the pressure electrode 720 shorter than a relative distance from the third reference potential layer 820 to the pressure electrode 720, the air gap may be increased. In this case, the pressure detection can be performed by the pressure electrode 720 and the second reference potential layer 810.

Also, the relative distance from the second reference potential layer 810 to the pressure electrode 720 can be controlled by the thickness of the elastic foam member 720. Together with the air gap, the elastic foam member 730 can make the relative distance from the second reference potential layer 810 to the third reference potential layer 820 shorter or longer. Likewise, it is possible to control the distance between the first reference potential layer 610 and the pressure electrode 720 by using the thickness of the insulation layer 710. Particularly, by appropriately controlling the thickness of the elastic foam member 720 and the thickness of the insulation layer 710, the relative distance between the pressure electrode 720 and the first reference potential layer 610 and the relative distance between the pressure electrode 720 and the second reference potential layer 810 can be controlled.

Through this, the reference potential layer which is used in the pressure detection module 400 performing the pressure detection may be selected due to the distance change. In order that a function as the reference potential layer can be accurately performed, it is preferable that the spaced distance between the reference potential layer and the pressure electrode 720 should be uniform with respect to the entire surface of the touch input device. In other words, it is preferable that the reference potential layer should have a planar shape as a whole. If the reference potential layer is uneven in a particular area or has an inclined area, it is difficult for the reference potential layer to accurately function as the reference potential layer.

The touch input device may include a plurality of components capable of functioning as the reference potential layer. However, in the process in which respective components for detecting the touch position and touch pressure in the touch input device are integrated, there are problems that any one of the components capable of functioning as the reference potential layer may have a non-uniform shape, may be uneven, or may include an inclined area by being pushed by other upper or lower components.

According to the embodiment of the present invention, when there are the plurality of reference potential layers, through the solution of the above problem, a reference potential layer which is the most suitable for detecting the touch pressure is selected among the plurality of reference potential layers or the plurality of reference potential layers may be used as a reference potential layer for the touch pressure detection by controlling the spaced distance, etc. That is, the reference potential layer having a non-uniform shape or height can be minimally involved in the pressure detection.

Here, the pressure detection is not limited to a specific method. As described above, the mutual capacitance change amount or the self-capacitance change amount may be used.

Specifically, in the case of using the self-capacitance change amount, the pressure detection module 700 detects the self-capacitance change amount according to the distance change between the pressure electrode 720 and one of the second reference potential layer 810 and the third reference potential layer 820. Here, the drive electrode or the receiving electrode may be used as the pressure electrode 720.

Also, in the case of using the mutual capacitance change amount, the pressure detection module 700 detects the mutual capacitance change amount between the drive electrode and the receiving electrode, according to the distance change between the pressure electrode 720 and one of the second reference potential layer 810 and the third reference potential layer 820. Sure enough, in this case, it is preferable that the pressure electrode 720 should have both the drive electrode and the receiving electrode.

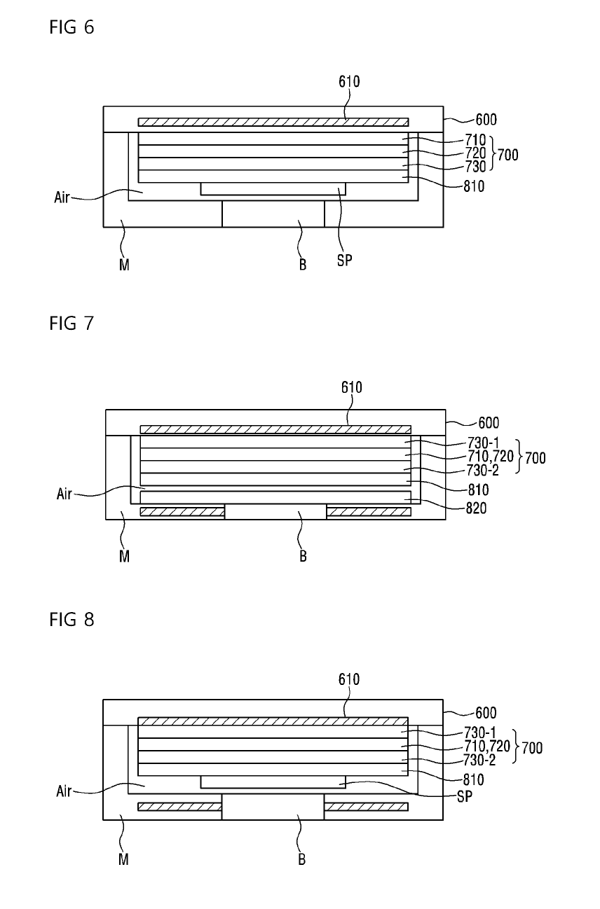

FIG. 6 is a schematic view showing the cross section of the touch input device according to still another embodiment of the present invention. While the configuration, operation, and effect are similar to those of the embodiment of FIG. 5, FIG. 6 shows that a shock absorbing layer SP may be further included under the second reference potential layer 810 under the pressure detection module 700. Also, the air gap may be present between the shock absorbing layer SP and a mid-frame M covering the component such as the shock absorbing layer SP, etc. The mid-frame M may correspond to the third reference potential layer 820 of FIG. 5. However, a relative distance between the mid-frame M of FIG. 6 and the pressure electrode 720 is large, and the mid-frame M has a non-uniform shape, that is to say, it is difficult for the mid-frame M to have a planar shape on the entire surface thereof. Therefore, it is preferable that the first reference potential layer 610 or the second reference potential layer 810 is used to detect the pressure.

Of course, the first reference potential layer 610 or the second reference potential layer 810 may be selected as the reference potential layer for the pressure detection in accordance with the thickness of the insulation layer 710 and the elastic foam member 730.

Meanwhile, in FIGS. 5 and 6, when the first reference potential layer 610 is used to detect the pressure, the configuration of the pressure detection module 700 may be changed. That is to say, in the pressure detection module 700 formed by stacking in the order of the elastic foam member 730, the pressure electrode 720, and the insulation layer 710 from the bottom, the pressure detection module 700 may be formed by stacking in the reverse order, in other words, in the order of the insulation layer 710, the pressure electrode 720, and the elastic foam member 730. This may be appropriately modified, changed or replaced by those skilled in the art, on the basis of the above-described pressure detection method.

FIG. 7 is a schematic view showing the cross section of the touch input device according to still another embodiment of the present invention. In the touch input device according to the embodiment of FIG. 7, the first reference potential layer 610 is provided within the display module 600 or on the bottom surface of the display module 600, and the pressure detection module 700 is located under the display module 600. The second reference potential layer 810 and the third reference potential layer 820 are located under the pressure detection module 700. A predetermined air gap may be formed between the second reference potential layer 810 and the third reference potential layer 820.

Unlike FIGS. 5 and 6, the pressure detection module 700 provided in the embodiment of FIG. 7 includes two elastic foam members 730-1 and 730-2. Also, the insulation layer 710 and pressure electrode 720 are provided between the upper elastic foam member 730-1 and the lower elastic foam member 730-2. Here, the insulation layer 710 and pressure electrode 720 may form an appropriately shaped stack structure.

In the pressure detection module 700 having the structure of FIG. 7, even though any of the first to the third reference potential layers 610, 810, and 820 which can be used as the reference potential layer is used, the pressure detection is easily made. Needless to say, the pressure detection can be also made by using the plurality of reference potential layers.

For example, in consideration of the distance between the pressure electrode 720 and the reference potential layer or of the stacking relationship with other components, in the case where it is preferable that the first reference potential layer 610 is used to detect the pressure, the distance between the pressure electrode 720 and the first reference potential layer 610 may be changed by the upper elastic foam member 730-1. Likewise, in the case where it is preferable that the second reference potential layer 810 is used to detect the pressure, the distance between the pressure electrode 720 and the second reference potential layer 810 may be changed by the lower elastic foam member 730-2. The pressure detection module 700 detects the touch pressure by using the self-capacitance change amount or the mutual capacitance change amount, in accordance with the distance change between the reference potential layer and the pressure electrode 720.

Specifically, in the case of using the self-capacitance change amount, the pressure detection module 700 detects the self-capacitance change amount according to the distance change between the first reference potential layer 610 and the pressure electrode 720 or the distance change between the second reference potential layer 810 and the pressure electrode 720. Here, the drive electrode or the receiving electrode may be used as the pressure electrode 720.

Also, in the case of using the mutual capacitance change amount, the pressure detection module 700 detects the mutual capacitance change amount between the drive electrode and the receiving electrode in accordance with the distance change between the first reference potential layer 610 and the pressure electrode 720 or the distance change between the second reference potential layer 810 and the pressure electrode 720. Of course, in this case, it is preferable for the pressure electrode 720 to include both the drive electrode and the receiving electrode.

Meanwhile, in the embodiment of FIG. 7, the mid-frame M may be another reference potential layer. However, since the mid-frame M integrates and covers other components other than the components shown in FIG. 7, the mid-frame M may not be planar as a whole. In this case, the above-mentioned problems occur, and thus, the mid-frame M may not be used as the reference potential layer.

Likewise, if the first to the third reference potential layers 610, 810, and 820 do not have a uniform shape (a flat surface) as a whole, they may be excluded from the touch pressure detection. Here, the relative distance between the pressure electrode 720 and the reference potential layer is changed by controlling the thickness of at least one of the upper elastic foam member 730-1, the lower elastic foam member 730-2, the insulation layer 710, and the air gap, so that the optimal reference potential layer for the touch pressure can be set.

Similarly to FIG. 7, the touch input device according to the embodiment of FIG. 8 includes the pressure detection module 700 including the two elastic foam members 730-1 and 730-2. Also, the touch input device according to the embodiment of FIG. 8 includes the second reference potential layer 810 formed under the pressure detection module 700. The shock absorbing layer SP is present under the second reference potential layer 810. Also, the air gap is present between the mid-frame M and shock absorbing layer SP.

Also in the embodiment of FIG. 8, the mid-frame M is able to function as the reference potential layer. However, in order for the mid-frame M to accurately perform the function as the reference potential layer, it is required that the spaced distance from the entire surface of the reference potential layer to the pressure electrode 720 should be uniform. Here, if the mid-frame M has a non-uniform shape, it is preferable that the mid-frame M is not used as the reference potential layer.

Therefore, in the embodiment of FIG. 8, the pressure detection can be made by using the first reference potential layer 610 disposed within or under the display module 610 or the second reference potential layer 810 disposed under the pressure detection module 700.

When the first reference potential layer 610 is used to detect the pressure, the distance between the pressure electrode 720 and the first reference potential layer 610 is changed by the upper elastic foam member 730-1. In this case, the thickness of the lower elastic foam member 730-2 may become relatively larger. Of course, in some cases, it may be preferable to make the thickness of the lower elastic foam member 730-2 relatively small.

Also, when the second reference potential layer 810 is used to detect the pressure, the distance between the pressure electrode 720 and the second reference potential layer 810 is changed by the lower elastic foam member 730-2. In this case, the thickness of the upper elastic foam member 730-1 may become relatively larger. Of course, in some cases, it may be preferable to make the thickness of the upper elastic foam member 730-1 relatively small.

The reference potential layer for the touch pressure detection may be selected by the material, shape, plan view, size, etc., of the first reference potential layer 610 and the second reference potential layer 810.

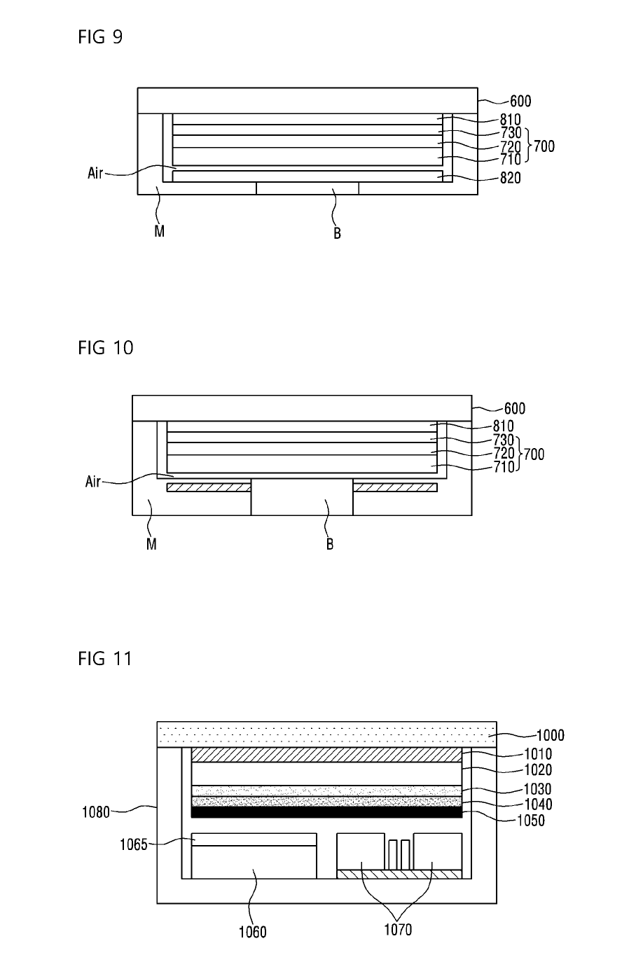

In the embodiment of FIG. 9, the first reference potential layer 810 is placed under the display module 600. Also, the pressure detection module 700 is placed under the first reference potential layer 810. The second reference potential layer 820 is placed under the pressure detection module 700.

As shown in FIG. 9, when the second reference potential layer 820 is located adjacent to the mid-frame M and a battery B, the second reference potential layer 820 may include an inclined or uneven nonplanar area. This is not appropriate for the touch pressure detection.

Therefore, as shown in the embodiment of FIG. 9, it is preferable that the reference potential layer including the nonplanar area is excluded from the touch pressure detection and that the first reference potential layer 810, i.e., the reference potential layer other than the reference potential layer including the nonplanar area is used to detect the touch pressure. Therefore, in the embodiment of FIG. 9, the thickness of the insulation layer 710 may become relatively larger in order to exclude the second reference potential layer 820 from the touch pressure detection.

The elastic foam member 730 of the pressure detection module 700 is located just under the first reference potential layer 810, so that the distance change between the first reference potential layer 810 and the pressure electrode 720 can be ensured. Here, the elastic foam member 730 may be formed to have an appropriate thickness enabling the touch pressure detection based on the self-capacitance change amount.

In the embodiment of FIG. 10, the second reference potential layer does not exist separately and the mid-frame M may function as the reference potential layer. The form or shape of the mid-frame M may not be suitable for being used in the pressure detection. In this case, only the first reference potential layer 810 placed on the pressure detection module 700 may be used in the pressure detection.

Therefore, as with FIG. 9, the elastic foam member 730 is placed between the first reference potential layer 810 and the pressure electrode 720 of the pressure detection module 700, so that the distance change between the first reference potential layer 810 is ensured.

In such a structure, the pressure detection module 700 detects the touch pressure on the basis of the self-capacitance change amount according to the distance change between the pressure electrode 720 and the first reference potential layer 810 and the mutual capacitance change amount between the drive electrode and the receiving electrode, according to the distance change between the pressure electrode 720 and the first reference potential layer 810.

According to the touch input device of FIGS. 5 to 10, when the plurality of reference potential layers having various forms and shapes are provided, it becomes easy to select the reference potential layer for detecting the touch pressure, and a specific reference potential layer is excluded from the touch pressure detection by controlling the thickness of at least one of the elastic foam member, insulation layer, and air gap, so that the touch pressure can be more efficiently detected.

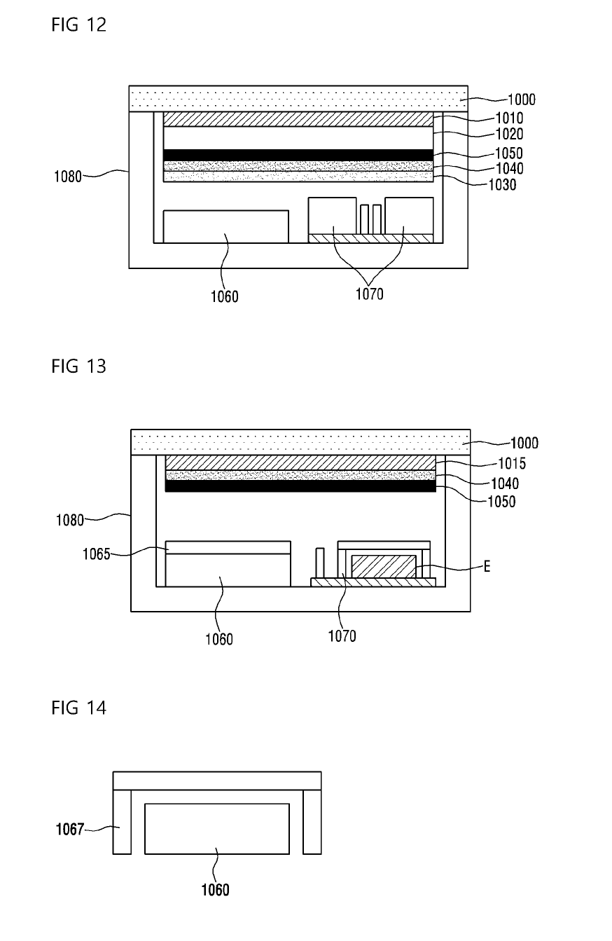

FIGS. 11 and 12 are cross sectional views of the touch input device according to still another embodiment of the present invention.

Not only the display module but also a battery 1060 which supplies driving electric power and a can 1070 which receives or fixes various components required to drive the device may be provided within a frame 1080 of the touch input device. In particular, the can 1070 can be used as the reference potential layer for the pressure detection because the can 1070 can be connected to the ground (GND). Hereinafter, an embodiment in which the battery 1060 and the can 1070 are used as the reference potential layer will be described.

FIGS. 11 and 12 show the display module using an LCD panel. The display module includes the LCD panel 1010 and a backlight unit 1020. These are received within the frame 1080. Meanwhile, a cover glass 1000 may be formed on a display surface of the display module.

A pressure detection module 1050 is provided under the backlight unit 1020 of the display module. While FIG. 11 shows that a metal cover 1030 and an elastic material 1040 are provided between the backlight unit 1020 and the pressure detection module 1050, the metal cover 1030 and the elastic material 1040 may be omitted in another embodiment, or alternatively, a configuration other than this may be inserted between the backlight unit 1020 and the pressure detection module 1050.

The metal cover 1030 functions to block an electromagnetic wave as well as firmly fixes the display module. Therefore, it is preferable that the metal cover 1030 should be made of a metallic material having a predetermined rigidity capable of blocking an external impact. The elastic material 1040 is placed under the metal cover 1030 and functions to protect the internal components (in particular, the display module) of the touch input device by absorbing the external impact. Therefore, it is preferable that the elastic material 1040 should be made of a material having elasticity to absorb the impact. However, the metal cover 1030 and the elastic material 1040 may be omitted or replaced by another component having the same function as this. Of course, unlike FIG. 11, the positions of both the metal cover 1030 and the elastic material 1040 can be swapped with each other, and the metal cover 1030 and the elastic material 1040 may be formed only on some areas instead of on the entire bottom area of the display module. In other words, in the embodiment of the present invention, the position, material, and shape of the metal cover 1030 and the elastic material 1040 are not limited to this.

Since the detailed configuration of the pressure detection module 1050 provided under the display module has been described above, the detailed description thereof will be omitted herein. The pressure electrode included in the pressure detection module 1050 is used to sense the capacitance change amount according to the distance change between the pressure electrode and the reference potential layer. In the embodiment of FIG. 11, the components (at least one of the battery 1060 and the can 1070) provided under the pressure detection module 1050 is used as the reference potential layer.

A conductive material-made tape layer or film layer may be formed on the top surface of the battery 1060. Also, the conductive material-made layer may be connected to the ground (GND) and may be used as the reference potential layer. Also, the conductive material layer formed on the top surface of the battery 1060 is spaced apart from the pressure detection module 1050 by a predetermined interval. When the distance between the pressure detection module 1050 and the top surface of the battery is reduced by the pressure applied by the touch of the object, the capacitance (self-capacitance or mutual capacitance) is changed, and then the magnitude of the touch pressure can be detected on the basis of the capacitance change amount. If necessary, a plurality of the batteries 1060 may be provided.

Further, the can 1070 may receive or fix various components (e.g., IC, etc.) required to drive the device equipped with the touch input device, may be made of a metallic material, and may be connected to the ground (GND). Here, it is enough as long as the material is connected to the ground (GND) and is used as the reference potential layer, and the material of the can is not limited to the metallic material. The can 1070 may have various shapes and sizes in accordance with the received components. In particular, the can 1070 has a function of shielding various components received therewithin, thereby blocking the introduction of an external signal or emission of an internal signal. A spaced space is also present between the can 1070 and the pressure detection module 1050. When the distance between the pressure detection module 1050 and the can 1070 is reduced by the pressure applied by the touch of the object, the capacitance (self-capacitance or mutual capacitance) is changed, and then the magnitude of the touch pressure can be detected on the basis of the capacitance change amount. A varying number of the cans 1070 used as the reference potential layer may be provided.

Here, the conductive material layer formed on the top surface of the battery 1060 may be used as the reference potential layer through the connection to the can 1070 without being separately connected to the ground (GND).

Here, the spaced distance from the battery 1060 to the pressure detection module 1050 and the spaced distance from the can 1070 to the pressure detection module 1050 may be different from each other. Also, the spaced distances from the plurality of cans 1070 to the pressure detection module 1050 may be different from each other. In this case, although a touch sensitivity may not be uniform according to the area of the touch surface, the touch sensitivity may be uniformly corrected through calibration of the touch sensitivity for each area. Besides, the touch sensitivity for the entire touch surface can be uniformly corrected by the shape, thickness, interval, etc., of the pressure electrode included in the pressure detection module 1050.

In the embodiment of FIG. 12, unlike FIG. 11, the pressure detection module 1050 is provided adjacent to the display module. Specifically, the pressure detection module 1050 is provided under the backlight unit 1020.

The pressure detection module 1050 includes the pressure electrode for detecting the touch pressure according to the distance change between the reference potential layer and the pressure electrode. The elastic material 1040 for ensuring the distance change may be disposed. The elastic material 1040 of FIG. 12 may correspond to the elastic foam member 440 shown in FIGS. 4a to 4f. The pressure detection module 1050 of FIG. 12 may be described as having only the pressure electrode. Here, although the elastic foam member 440 corresponds to a component for ensuring the distance change between the pressure electrode and the reference potential layer, the elastic foam member 440 can be also used as a shock absorbing material for protecting the component such as the display module, etc., from the external impact. The metal cover 1030 is provided under the elastic material 1040. The metal cover 1030 may be connected to the ground (GND) and may be used as the reference potential layer. That is, in the embodiment of FIG. 12, when the pressure is applied by the touch of the object, the pressure detection module 1050 senses the magnitude of the touch pressure on the basis of the capacitance change amount according to the distance change between the metal cover 1030 and the pressure electrode within the pressure detection module 1050. Also, in the embodiment of FIG. 12, the conductive material layer connected to the ground (GND) does not need to be formed on the battery 1060 because the battery 1060 or the can 1070 which is provided under the metal cover 1030 is not used as the reference potential layer.

FIG. 13 is a cross sectional view of the touch input device according to still another embodiment of the present invention. Unlike FIGS. 11 and 12, the display module of FIG. 13 may include an OLED panel, in particular, an AM-OLED panel.

The OLED panel is a self-light emitting display panel which uses a principle in which a current is caused to flow through a fluorescent or phosphorescent organic thin film and then electrons and electron holes are combined in the organic layer, so that light is generated. The organic matter constituting the light emitting layer determines the color of the light.

Specifically, the OLED uses a principle in which when electricity flows and an organic matter is applied on glass or plastic, the organic matter emits light. That is, the principle is that electron holes and electrons are injected into the anode and cathode of the organic matter respectively and are recombined in the light emitting layer, so that a high energy exciton is generated and the exciton releases the energy while falling down to a low energy state and then light with a particular wavelength is generated. Here, the color of the light is changed according to the organic matter of the light emitting layer.

The OLED includes a line-driven passive-matrix organic light-emitting diode (PM-OLED) and an individual driven active-matrix organic light-emitting diode (AM-OLED) in accordance with the operating characteristics of a pixel constituting a pixel matrix. None of them require a backlight. Therefore, the OLED enables a very thin display module to be implemented, has a constant contrast ratio according to an angle and obtains a good color reproductivity depending on a temperature. Also, it is very economical in that non-driven pixel does not consume power.

In terms of operation, the PM-OLED emits light only during a scanning time at a high current, and the AM-OLED maintains a light emitting state only during a frame time at a low current. Therefore, the AM-OLED has a resolution higher than that of the PM-OLED and is advantageous for driving a large area display panel and consumes low power. Also, a thin film transistor (TFT) is embedded in the AM-OLED, and thus, each component can be individually controlled, so that it is easy to implement a delicate screen.

In the embodiment of FIG. 13, the backlight unit is not present between an OLED panel 1015 and the pressure detection module 1050. Therefore, the thickness of the touch input device can be further reduced. However, the elastic material 1040 may be provided in order to protect the internal components such as the OLED panel 1015, etc., from the external impact. FIG. 13 shows that the elastic material 1040 is provided between the OLED panel 1015 and the pressure detection module 1050. However, in still another embodiment, the elastic material 1040 may be provided at another position or may be omitted in some cases.

The operation method of FIG. 13 is the same as that of FIG. 11. That is, the touch pressure can be detected by using the battery 1060 and the can 1070, which are provided under the pressure detection module 1050, as the reference potential layer. Meanwhile, although, with regard to FIGS. 11 and 13, it has been described that the conductive material layer is present on the top surface of the battery 1060 and is connected to the ground (GND), the can 1060 covering the battery 1060 may be, as shown in FIG. 14, connected to the ground (GND) and then used as the reference potential layer. Here, the can 1060 covering the battery 1060 may be connected to the can 1070 for receiving or fixing other components and used as the reference potential layer. Through the implementation of the embodiment of FIG. 14, it is possible to prevent the external impact from being transmitted to the battery 1060.

According to the embodiments of FIGS. 11 to 14, various components provided in the touch input device can be used as the reference potential layer, so that a separate reference potential layer does not need to be formed. Therefore, the economic efficiency of the manufacturing process can be improved and manufacturing cost can be reduced.

Also, although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A touch input device which comprises a display module and is capable of detecting a touch pressure, the touch input device comprising:
a pressure detection module which is provided under the display module and comprises a pressure electrode for detecting the touch pressure; and
a reference potential layer which is provided under the pressure detection module,
wherein the pressure detection module detects the touch pressure on the basis of a capacitance change amount according to a distance change between the reference potential layer and the pressure electrode,
and wherein the reference potential layer is composed of at least one of a battery having a conductive material and a can receiving other components.

2. The touch input device of claim 1, wherein the battery is covered by the conductive material-made can connected to the ground (GND).

3. The touch input device of claim 1, wherein a conductive material-made tape layer or film layer connected to the ground (GND) is formed on the battery.

4. The touch input device of claim 1, wherein at least one of a metal cover and an elastic material is provided between the display module and the pressure detection module.

5. The touch input device of claim 1, wherein the display module comprises an LCD panel and a backlight unit, and wherein the pressure detection module is provided under the backlight unit.

6. The touch input device of claim 1, wherein the display module comprises an AM-OLED panel.

7. The touch input device of claim 1, wherein the capacitance change amount is a self-capacitance change amount according to the distance change between the reference potential layer and the pressure electrode.

8. The touch input device of claim 1, wherein the pressure electrode comprises a drive electrode and a receiving electrode, and wherein the capacitance change amount is a mutual capacitance change amount between the drive electrode and the receiving electrode, according to the distance change between the reference potential layer and the pressure electrode.
